(19) United States
(12) Patent Application Publication
(10) Pub. No.: US 2008/0311890 A1
(43) Pub. Date: Dec. 18, 2008

(54) IMS network support for remote video recording and access

(76) Inventors: David S. Benco, Winfield, IL (US); Sanjeev Mahajan, Naperville, IL (US); Baoling S. Sheen, Naperville, IL (US); Sandra L. True, St. Charles, IL (US)

Correspondence Address: PATTI , HEWITT & AREZINA LLC, ONE NORTH LASALLE STREET, 44TH FLOOR, CHICAGO, IL, 60602, US

(21) Appl. No.: 11/818,070

(22) Filed: Jun. 13, 2007

(51) Int. Cl. H04M 3/42

(52) U.S. Cl. 455/414.1

(57) ABSTRACT

A method in one example has: registering remotely controlled devices and terminals of subscribers with at least one remote service server in an IMS network, the remotely controlled devices having respective IMS clients, and the terminals of the subscribers having respective IMS clients; and allowing the terminals of the subscribers to interface with respective remotely controlled devices via the IMS network. A subscriber is able to control a remote video recording device, for example, change channels, view scheduled programs, schedule recording, view a previously recorded program or a program currently being aired via the IMS network.

### TECHNICAL FIELD

The invention relates generally to telecommunication networks, and more particularly to an IMS network for remote video recording and access.

### BACKGROUND

Many types of recording devices are known. For example, many people own video and audio recording devices that typically can be controlled remotely using radio frequency or infrared, or by the use of timers. How often has a person left home and forgot to set the timer to record a favorite program, or been on a business trip sitting in a hotel not able to access the cable channels that are subscribed to, or view a program that was recorded previously at home?

Thus, persons away from home may have very limited access to desired programming. Although, there are some video services being offered over packet networks, the content is limited to the content provided by the content/service provider. Such content is usually small clips of news, movie trailers etc. This content is very different and is not what a subscriber subscribes to from their cable company. The prior art does not allow a subscriber to access the programming of their choice, when they want it, from where they want it, from where they want to and to specify future programming remotely.

Therefore, there is a need for an improved method and system for interfacing with remotely controlled devices, such as home recording equipment, via a telecommunication network.

### SUMMARY

One implementation encompasses an apparatus. This embodiment of the apparatus may comprise: at least one video recording device, having an IMS client, operatively coupled to an IMS call session control function in an IMS network; at least one terminal, having an IMS client, operatively coupled to the IMS call session control function in the IMS network, the at least one video recording device being associated with the at least one terminal; a remote video service application server, having an IMS server, operatively coupled to the IMS call session control function in the IMS network; a menu which allows the video recording device and its various functions to be operated from the terminal via the IMS network, the menu provided by the remote video service application server; and commands sent from the terminal of the subscriber to the associated video recording device for operation of the video recording device.

Another implementation encompasses a method. This embodiment of the method may comprise: registering remotely controlled devices and terminals of subscribers with at least one remote service server in an IMS network, the remotely controlled devices having respective IMS clients, and the terminals of the subscribers having respective IMS clients; and allowing the terminals of the subscribers to interface with respective remotely controlled devices via the IMS network.

### DESCRIPTION OF THE DRAWINGS

The features of the embodiments of the present method and apparatus are set forth with particularity in the appended claims. These embodiments may best be understood by reference to the following description taken in conjunction with the accompanying drawings, in the several figures of which like reference numerals identify like elements, and in which:

FIG. 1 is a representation of one implementation according to the present apparatus of an IMS network that supports remote video recording and access;

FIG. 2 is a representation of one exemplary flow diagram according to the present method for an IMS network supporting remote video recording and access; and

FIG. 3 is a representation of another exemplary flow diagram according to the present method for an IMS network supporting remote video recording and access.

### DETAILED DESCRIPTION

Embodiments according to the present method and apparatus provide a service to IMS subscribers and allows them to interface with remotely controlled devices. For example, it allows subscribers to record TV/Cable programs remotely and access them remotely.

Remotely controlled devices may refer to any type of remotely controlled equipment. In particular, it may refer to home devices, such as video recording devices, audio recording devices, etc.

An IMS (IP Multimedia Subsystem, also referred to as IP Multimedia Core Network Subsystem) is a collection of different functions, linked by standardized interfaces, which grouped form an IMS network.

A user can connect to an IMS network using various methods, however each of these methods use the standard Internet Protocol (IP). Direct IMS terminals, such as mobile phones, PDAs, computers, etc., can register directly into an IMS network. The only requirement is that they can use IP and are running Session Initiation Protocol (SIP) user agents. Various types of access to the IMS network are possible, such as, fixed access (e.g., DSL, cable modems, Ethernet, etc.), mobile access (W-CDMA, CDMA2000, GSM, GPRS, etc.) and wireless access (WLAN, WiMAX, etc.).

The HSS (Home Subscriber Server) is the user database that supports the IMS network entities that are actually handling the calls/sessions. It contains the subscription-related information (user profiles), performs authentication and authorization of the user, and can provide information about the physical location of user.

Application servers (AS) act as hosts and execute services, and interface using SIP. There may be a variety of application servers corresponding to a variety of functions and services. IMS architecture has different types of application servers. For example, for processing a VoIP call from a VoIP terminal there is a feature server (also referred to as an application server). The VoIP terminal has a VoIP client in it.

A methodology of the present method and apparatus is for a recording device to support remote access and interface to an IMS Application Server (Remote Video Service Server).

Another methodology of the present method and apparatus is for a subscriber to log into the remote video service server and access their domestic video recording device.

A further methodology of the present method and apparatus is for a subscriber to be able to control a domestic video recording device, for example, change channels, view scheduled programs, schedule recording, view a previously recorded program or a program currently being aired.

For the example for a video recording device, the video recording device may support an IP Interface and a remote video access client. The remote video access client may interface with a remote video service server via an IMS network. The remote video access client operates as an IMS application client and interfaces to an IMS call session control function. The remote video service server may be an application server in the IMS network and interfaces to the IMS call session control function.

The video recording device may register with the remote video service server when it is turned on and de-registers when it is turned off. The subscriber of the service may, for example, log onto the remote video service server via their IMS cellular phone or PC (personal computer) via a remote video access client installed in the phone or PC. The subscriber may, then issue commands using a protocol to access their video recording device to, for example, change the channel, view the program guide, access and set the recording timer, retrieve the recorded programs and view them or a program being aired current on their remote PC or IMS mobile phone.

In one embodiment once the session is setup between the subscriber mobile phone and the remote video recorder, the application server is no longer involved in the session. When the subscriber terminates the call, the application is once again involved. Thus, the application server is involved for the signaling to set up and terminate the session, but the actual transfer of data for the session passes directly between the subscriber's terminal and the home device.

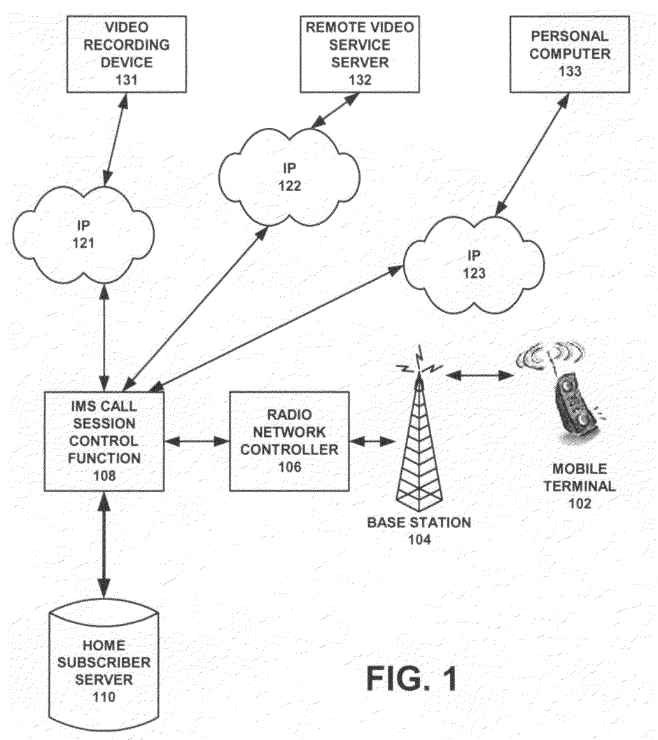

FIG. 1 is a representation of one implementation of an apparatus that provides for an IMS network supporting remote video recording and access. Many configurations with various types of equipment may utilize the embodiments according to the present method and apparatus. In the depicted embodiment a mobile terminal 102 may be operatively coupled to a radio network controller 106 by a base station 104. The radio network controller 106 may be operatively coupled to an IMS call session control function 108. The IMS call session control function 108 may be operatively coupled to a home subscriber server 110. A video recording device 131 may be operatively coupled to the IMS call session control function 108 via an IP network 121; a remote video service server 132 may be operatively coupled to the IMS call session control function 108 via an IP network 122; and a personal computer 133 may be operatively coupled to the IMS call session control function 108 via an IP network 123. The video recording device 131 may be operatively coupled by the remote video service server 132 to various equipment of a subscriber, such as personal computer 133 or mobile terminal 102.

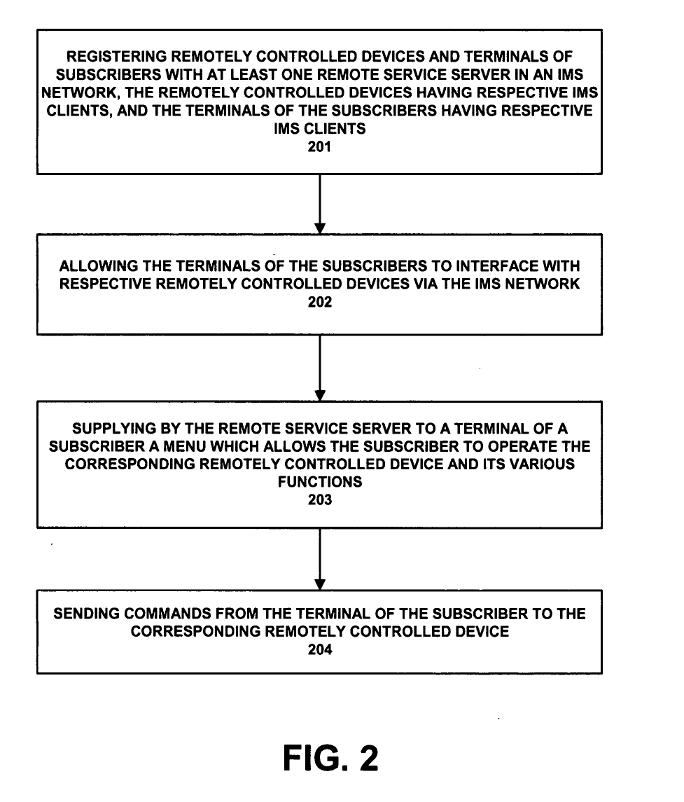

FIG. 2 is a representation of one exemplary flow diagram according to the present method for an IMS network supporting remote video recording and access. This embodiment of the present method may have the following steps: registering remotely controlled devices and terminals of subscribers with at least one remote service server in an IMS network, the remotely controlled devices having respective IMS clients, and the terminals of the subscribers having respective IMS clients (201); allowing the terminals of the subscribers to interface with respective remotely controlled devices via the IMS network (202); supplying by the remote service server to a terminal of a subscriber a menu which allows the subscriber to operate the remotely controlled device and its various functions (203); and sending commands from the terminal of the subscriber to the corresponding remotely controlled device (204).

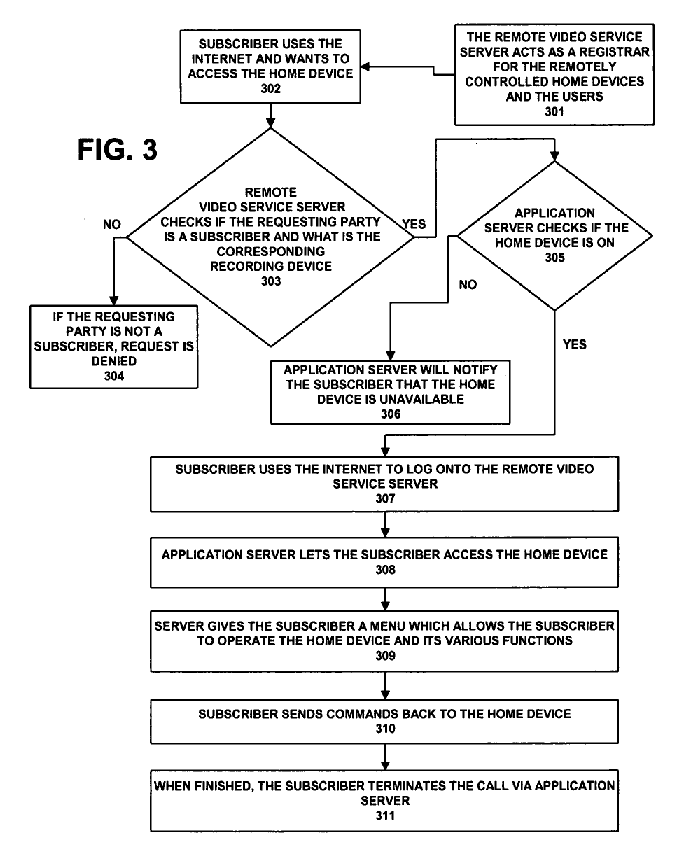

FIG. 3 is a flow diagram of one embodiment according to the present method and apparatus for remote video recording and access. First the remote video service server acts as a registrar for the remotely controlled home devices and the users (301). When a user purchases a video recording device, for example, which is enabled for this service, it will have an IMS client in it. When the video recording device is powered up and goes on line for the first time, it will register itself with the application server. This may include, for example, an identification, an address, etc.

When a subscriber is using, for example, the Internet and wants to access the home device (302), the remote video service server then checks if the requesting party is a subscriber and what is the corresponding recording device (303). If the requesting party is not a subscriber, request is denied (304). The application server then checks if the home device is on or off (305). If the home device is off, the application server will notify the subscriber that the home device is unavailable (306). If the home device is on, the subscriber then uses the Internet to log on to the remote video service server (307). The application server will then let the subscriber access the home device (308).

Although this example uses the Internet, other communication systems may be used such as an IMS capable satellite phone which has the client built into it. There are two clients, one client that is in the video recording device, and another client is in the computer or phone that allows the subscriber to access the server and view programming from that server.

When the subscriber logs onto the remote video service server, and has access to the home device, the server may give the subscriber a menu which allows the subscriber to operate the home device and its various functions (309). It may allow, for example, streaming video of a programming guide from the home device to the computer, mobile phone, satellite phone, etc. The subscriber may then send commands back to the home device (310). For example, the operation may be similar to using the typical infrared or radio frequency remote controller for the home device. When finished, the subscriber may then terminate the call via application server (311).

When the subscriber chooses to watch the previously recorded and a live program remotely the resolution of the video is negotiated based on the available band width, the desired quality of service and the requesting device type.

The present apparatus in one example may comprise a plurality of components such as one or more of electronic components, hardware components, and computer software components. A number of such components may be combined or divided in the apparatus.

The present apparatus in one example may employ one or more computer-readable signal-bearing media. The computer-readable signal-bearing media may store software, firmware and/or assembly language for performing one or more portions of one or more embodiments. Examples of a computer-readable signal-bearing medium for the apparatus may comprise the recordable data storage medium (subscriber database). The computer-readable signal-bearing medium for the apparatus in one example may comprise one or more of a magnetic, electrical, optical, biological, and atomic data storage medium. For example, the computer-readable signal-bearing medium may comprise floppy disks, magnetic tapes, CD-ROMs, DVD-ROMs, hard disk drives, and electronic memory. In another example, the computer-readable signal-bearing medium may comprise a modulated carrier signal transmitted over a network comprising or coupled with the apparatus, for instance, one or more of a telephone network, a local area network (“LAN”), a wide area network (“WAN”), the Internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. A method, comprising:
registering remotely controlled devices and terminals of subscribers with at least one remote service server in an IMS network, the remotely controlled devices having respective IMS clients, and the terminals of the subscribers having respective IMS clients; and
allowing the terminals of the subscribers to interface with respective remotely controlled devices via the IMS network.

2. The method according to claim 1, wherein the remote service server supplies a terminal of a subscriber a menu which allows the subscriber to operate the remotely controlled device and its various functions.

3. The method according to claim 1, wherein commands are sent from a terminal of the subscriber to a corresponding remotely controlled device.

4. The method according to claim 1, wherein, when finished, the subscriber terminates a connection to the remotely controlled device via the remote service server.

5. The method according to claim 1, wherein the subscriber uses a mobile terminal to access the remotely controlled device.

6. The method according to claim 1, wherein the remotely controlled device is a remote video recorder and wherein the remote service server is a remote video service server.

7. The method according to claim 6, wherein the remote service server supplies a terminal of the subscriber streaming video of a programming guide for the remotely controlled device.

8. A method, comprising:
registering remotely controlled home devices and subscribers with a server;
requesting access to a corresponding home device;
checking if a requesting party is a subscriber and identifying the corresponding home device;
denying the request, if the requesting party is not a subscriber;
checking if the home device is on;
notifying the subscriber that the home device is unavailable, if the home device is off;
logging the subscriber onto the server, if the home device is on; and
allowing the subscriber to access the home device.

9. The method according to claim 8, wherein the server supplies a terminal of the subscriber a menu which allows the subscriber to operate the home device and its various functions.

10. The method according to claim 8, wherein the server supplies a terminal of the subscriber streaming video of a programming guide for the home device.

11. The method according to claim 8, wherein commands are sent from a terminal of the subscriber to the home device.

12. The method according to claim 8, wherein, when finished, the subscriber terminates a connection to the home device via the server.

13. The method according to claim 8, wherein the subscriber uses a mobile terminal to access the home device.

14. The method according to claim 8, wherein the home device is a remote video recorder, and wherein the server is a remote video service server.

15. The method according to claim 14, wherein the remote video service server is an application server in an IMS network, and wherein the home device has an IMS client, and wherein a terminal of the subscriber has an IMS client.

16. The method according to claim 15, wherein the remote video service server negotiates the resolution of the video based on the available band width, the desired quality of service and the requesting device type.

17. An apparatus, comprising:
at least one video recording device, having an IMS client, operatively coupled to an IMS call session control function in an IMS network;
at least one terminal, having an IMS client, operatively coupled to the IMS call session control function in the IMS network, the at least one video recording device being associated with the at least one terminal;
a remote video service application server, having an IMS client, operatively coupled to the IMS call session control function in the IMS network;
a menu which allows the video recording device and its various functions to be operated from the terminal via the IMS network, the menu provided by the remote video service application server; and
commands sent from the terminal of the subscriber to the associated video recording device for operation of the video recording device.

18. The apparatus according to claim 17, wherein, when finished, the subscriber terminates a connection to the video recording device via the remote video service application server.

19. The apparatus according to claim 17, wherein the subscriber uses a mobile terminal to access the video recording device.

20. The apparatus according to claim 17, wherein the remote video service server acts as a registrar for the video recording device and the terminal, and wherein the apparatus further comprises a home subscriber server in which is stored information regarding the terminal and the associated video recording device.

21. The apparatus according to claim 17, wherein the remote video service application server supplies the terminal of the subscriber streaming video of a programming guide for the video recording device.
